(19) United States
(12) Patent Application Publication
(10) Pub. No.: US 2013/0061935 A1
(43) Pub. Date: Mar. 14, 2013

(54) SUCTION DEVICE AND SUCTION METHOD

(71) Applicant: Egon Evertz, Solingen (DE)

(72) Inventor: Egon Evertz, Solingen (DE)

(21) Appl. No.: 13/634,262

(22) PCT Filed: Jun. 1, 2011
(86) PCT No.: PCT/DE11/01192

§ 371 Date: Sep. 12, 2012

(30) Foreign Application Priority Data
Jun. 2, 2010 (DE) 10 2010 022 478.2

(51) Int. Cl. F03B 11/00

(52) U.S. Cl. 137/1; 137/561 R

(57) ABSTRACT

The invention relates to a device and a method for drawing off liquids and/or suspensions below the surface of water, with a bell element disposed at the end and a suction pipe disposed thereon. According to the invention, at least one compressed air supply line (4) discharges into the suction pipe (3) or into the bell element (2) in the lower region of the device. Preferably a plurality of compressed air supply lines is used, said supply lines discharging at spacings in the axial direction of the suction pipe and being acted upon by compressed air in succession from the top to the bottom.

The invention relates to an apparatus and a method for suctioning liquids and/or suspensions below the surface of the water, comprising a bell mounted at the end and a suction pipe mounted thereon.

The Deepwater Horizon disaster in the Gulf of Mexico has been in the headlines recently. The set of problems posed by this type of accident relates, in particular, to the immense quantities of oil that escape into the affected waters where they cause considerable damage to the flora and fauna both above and also below the surface of the water. When this happens, the oil forms wide carpets that can sometimes extend over several kilometers in length. Near coastlines, the oil accumulates on coral or other formations creating the coastline where even now the destruction of animal and plant life is evident.

Currently, the technology is still lacking that would enable a large quantity of oil, other harmful suspensions, or water-oil mixtures to be removed as rapidly as possible. Suctioning escaping oil, in particular, from an oil well at great depths poses major problems since significant pressure differences must be overcome and the suction force that can be applied from the surface has physical limits. On the other hand, it is significantly easier for technical reasons to generate high pressures that can easily be higher than the pressure found in deep regions of the ocean.

The object of this invention is create an apparatus and a method by which harmful liquids, suspensions, or other mixtures can be suctioned from below the surface of the water and thereby removed from the body of water.

This object is achieved by an apparatus as set forth in claim 1 and the method set forth in claim 8. According to the invention, the apparatus includes at least one compressed-air supply line that discharges into the suction pipe or into the bell at the lower region of the apparatus. The inflowing compressed air ascends inside the suction pipe, thereby creating a suction effect that causes the oil or the suctioned liquid mixture (in the form of an emulsion or suspension) to be transported upward. This enables large quantities of liquid, emulsions, or suspensions, such as, for example, oil or other chemicals, to be removed from the water within a short time period. Due to the very turbulent and thus rapid current inside the suction pipe, there is no problem of ice crystals forming inside the apparatus at great depths during the suction process, which ice crystals effectively impede suctioning as has occurred, for example, during suctioning trials in connection with the above-referenced accident at a depth of approximately 1500 m. The apparatus can, in particular, also be employed both in shallow and coastal waters and deep-sea regions.

Additional preferred embodiments are described below and in the dependent claims.

In a first preferred development of the apparatus, the compressed-air supply line is a hose that includes a nozzle that discharges into the apparatus in such a way that the compressed air is directed into the apparatus in an upward direction. The flow effect is created here by the fact that the injected air ascends inside the pipe. The transport effect increases here as the air ascends faster. As a result, an increased suction effect is provided by the preferred embodiment.

The suction effect is further enhanced in another embodiment in that the compressed-air supply line includes multiple nozzles that discharge into the apparatus spaced apart angularly. This type of annular nozzle not only allows the suction effect to be increased, it also allows a current to be created within which no ice crystals form and which effectively prevent any clumping together of oil inside the suction line. Multiple compressed-air supply lines are preferably provided that discharge at locations axially spaced along the suction pipe, thereby resulting in a uniform suction effect along the suction pipe. The number of compressed-air supply lines must be adjusted as a function of the depth of the liquid to be removed by suctioning.

In a preferred embodiment of this invention, the compressed-air supply lines discharge with essentially equidistant spacing, for example, 50 m to 100 m, axially along the entire length of the suction pipe. The selected spacings essentially depend on the water depth from which the suction removal process is to be effected, and on the available number of compressors.

Although the greatest suction effect is provided by those compressed-air supply lines that discharge into the lower region of the suction pipe, the specific design also enables the apparatus to be put into operation quickly and reliably even at great depths. That is because the suction effect is created by the compressed air ascending in the suction pipe. To this end, the hydrostatic pressure must first be overcome before the compressed air reaches the suction pipe. The preferred equidistant configuration enables the compressed-air supply lines to be controlled as a function of the depth at which they discharge into the suction pipe, with the result that the compressed-air supply lines can be supplied according to the invention with compressed air successively from top to bottom. At the top-most compressed-air supply line a low hydrostatic pressure is found that opposes the supply of compressed air due to the relatively small depth. As soon as compressed air is moved through the top-most compressed-air supply line into the suction pipe, a comparatively small suction effect is already created along the entire suction pipe. However, this simultaneously reduces the hydrostatic pressure at the other compressed-air supply lines, with the result that successively supplying pressure to the compressed-air supply lines enables the hydrostatic pressure prevailing at the compressed-air supply lines to be reduced that counteracts the supply of compressed air. This allows a sufficient supply of compressed air to be provided even at great depths.

As has already been mentioned, the applied pressure of the compressed air must be higher than the hydrostatic pressure prevailing at the depth of the water where the compressed air is injected; the compressed-air pressure is preferably between 10⁵ and to 3×10⁵ Pa higher than the given hydrostatic pressure. The distances between the compressed-air supply lines can also be unequal—for example, the first compressed-air supply line can be at 25 m, the second at 50 m, the third at 100 m, the fourth at 500 m, the fifth at 1000 m depth in the water, and, as required, each additional compressed-air supply line can be provided at a distance of 1000 m from the previous one. The difference between the hydrostatic pressure and the compressed-air pressure applied at the same location is either the same or decreases as the water depth increases, thereby enabling an increase in the suction effect to be achieved toward the surface of the water. The individual valves in each compressed-air supply line must be opened or closed by a controller. When the apparatus is started, the first compressed-air supply line is opened first at the smallest water depth and a compressed-air pressure is set that is gradually increased up to that maximum value specified for the water depth, which value is 3×10⁵ Pa above the hydrostatic pressure there. Following this, the second compressed-air supply line is opened and raised up to the desired maximum value, which process is repeated successively up to the last compressed-air supply line provided at the deepest point in the suction pipe.

Alternatively or additionally, it is also possible to use a different fluid or fluid mixture that optionally contains chemical additives that bind to the oil to be removed.

The bell is preferably funnel-shaped, frustoconical, or pyramid shaped. A bell of this type can be easily produced and is thus quickly available. The apparatus is preferably composed of iron, steel, or at least partially of reinforce concrete, which is also relatively inexpensive.

The following discussion describes a specific illustrated embodiment in more detail based on the drawing. Therein:

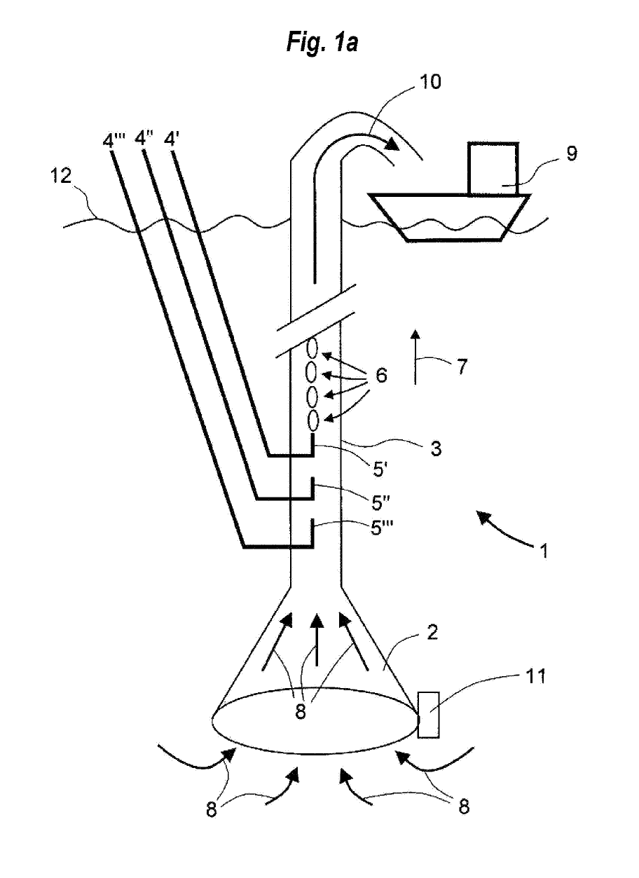

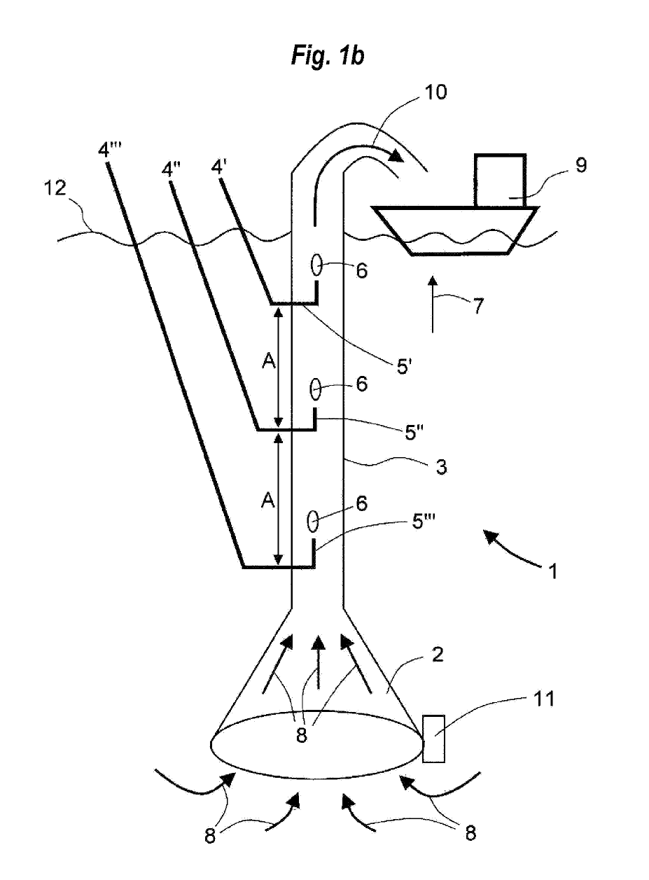

FIGS. 1a and 1b are schematic diagrams of the suction apparatus;

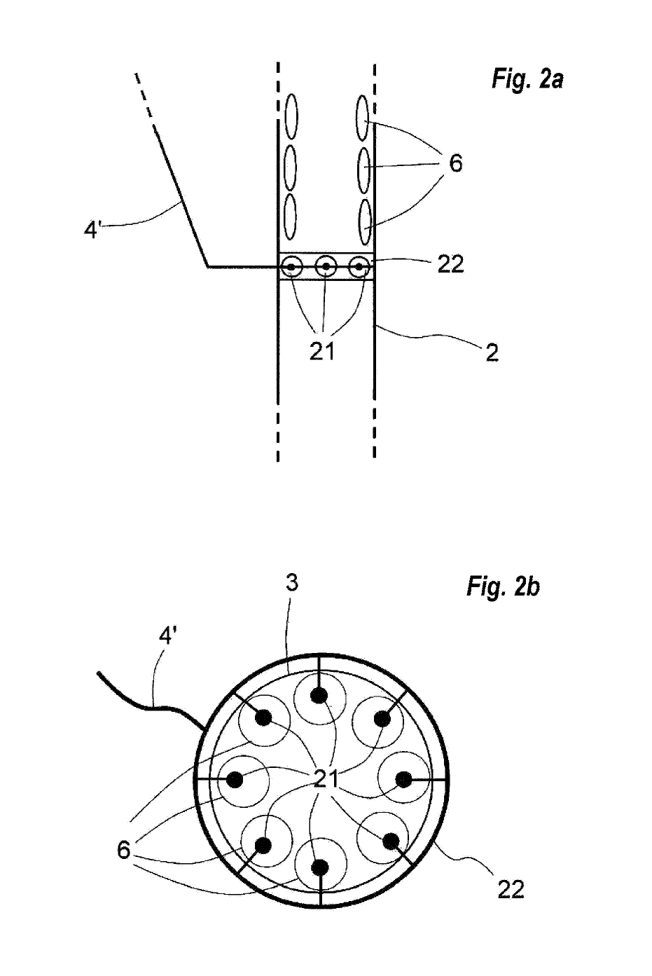

FIG. 2a is a side view of a suction pipe with multiple nozzles; and

FIG. 2b is a cross section through a suction pipe comprising eight discharging nozzles.

A suction apparatus 1, which in use is provided under the water surface 12, is comprised essentially of a funnel-shaped bell 2, a suction pipe 3, and compressed-air supply lines 4′, 4″, 4′″ that are spaced axially apart where they discharge into the suction pipe 3 at the lower region of the suction apparatus 1. At the same time, nozzles 5′, 5″, 5′″ at the end of the compressed-air supply lines 4′, 4″, 4′″ discharge into the suction apparatus 1 in such a way that the compressed air 6 is forced into the suction apparatus 1 in an upward direction (arrow 7). This creates a suction effect that draws in liquids and suspensions as shown by arrow 8 at the lower end of the suction apparatus 1. At the top end of the suction apparatus, the suction pipe discharges into the hull of a ship 9 (arrow 10), thereby enabling the fluids, emulsions, and suspensions to be removed. Finally, a camera 11 is provided at the lower end of the bell 2 to allow the movement of the bell to be controlled so that the appropriate underwater areas can be suctioned accurately.

FIG. 1b shows an embodiment in which three compressed-air supply lines 4′, 4″, 4′″ are provided that discharge into the suction pipe 3 at equidistant spacings A. In order to be able to convey the compressed air 6 into the suction pipe 3 at great depths where a pressure of approximately 200×10⁵ pascals (or 200 bar) is found 2000 m deep, first the compressed-air supply line 4 , then the compressed-air supply lines 4″ and 4′″ are supplied with pressure in succession. Due to the continuously increasing suction, the hydrostatic pressure is reduced, thereby allowing even compressed-air supply lines 4′, 4″, 4′″ at great depths to be supplied with pressure.

In another preferred embodiment of the suction apparatus 1, multiple nozzles 21 are provided in an annular configuration on the compressed-air supply lines 4′, 4″, 4′″, thereby forming the annular nozzle array 22 illustrated in FIGS. 2a and 2b. This creates the above-described strong current that prevents the suctioned gases and liquids, or the suctioned oil, from freezing or clumping together. The nozzles 21 are spaced apart equiangularly, as shown, in particular, in FIG. 2b.

1. An apparatus for suctioning liquids or suspensions below the surface of the water, the suctioning apparatus comprising:
an upright suction pipe having a lower end submerged in the water;
a bell mounted at the lower end; and
at least one compressed-air supply line discharging compressed air into the suction pipe or into the bell at a lower region of the suction pipe.

2. The apparatus according to claim 1, wherein the compressed-air supply line is a hose, and the supply line has a nozzle that discharges compressed air into the apparatus in such a way that the compressed air is forced into the suction pipe in an upward direction.

3. The apparatus according to claim 1, wherein there is a plurality of the nozzles mounted at an end of the compressed-air supply line and discharging compressed air radially into the suction pipe.

4. The apparatus according to claim 1, wherein there is a plurality of the compressed-air supply lines that are spaced apart axially of the suction pipe where they discharge into the suction pipe.

5. The apparatus according to claim 4, wherein the compressed-air supply lines discharge at essentially equidistant intervals along the entire length and axially of the suction pipe.

6. The apparatus according to claim 4, wherein the compressed-air supply lines can be controlled as a function of the depth at which they discharge into the suction pipe, with the compressed-air supply lines being pressurized successively from top to bottom.

7. The apparatus according to claim 1, wherein the bell is funnel-shaped, frustoconical, or pyramid-shaped.

8. A method of operating the claim 1 that has multiple compressed-air supply lines that are spaced apart axially of the suction pipe where they discharge, wherein the compressed-air supply lines are supplied with compressed air successively from top to bottom.
